(19) United States
(12) Patent Application Publication
(10) Pub. No.: US 2003/0062476 A1
(43) Pub. Date: Apr. 3, 2003

(54) Remote control electron microscope

(76) Inventor: Jang Yi Wang, Chong Ho City (TW)

Correspondence Address: Jang Yi WANG, P.O. Box 10-69, Chong Ho, Taipei, 235, TW

(21) Appl. No.: 09/968,213

(22) Filed: Sep. 28, 2001

(51) Int. Cl. G21K 7/00; G01N 23/00

(52) U.S. Cl. 250/306

(57) ABSTRACT

A remote control electron microscope includes an image taking device for taking image signals and for converting the image signals to radio frequency signals, and an image treating device having a receiver for receiving the radio frequency signal from the image taking device and having a device for demodulating the radio frequency signals to demodulated image signals and for displaying the demodulated image signals in a displayer. The image taking device may be freely moved to any position for appropriately take the required images and for taking the images from the best angles.

### BACKGROUND OF THE INVENTION

1. Field of the Invention

The present invention relates to an electron microscope, and more particularly to a remote control electron microscope.

2. Description of the Prior Art

Typical electron microscopes comprise an image taking device, such as a video camera, a charge coupled device, or the like, and an image treating device, such as a central processing unit or the like, coupled to the imaging taking device, with electric wires. Due to the electric-wire coupling of the image taking device to the imaging treating device, the image taking device may not be freely and suitably moved relative to the imaging treating device and thus may not be easily and freely moved to the required places or positions to appropriately take the required images, or may not be moved toward the best angle for taking the images from the best angles.

The present invention has arisen to mitigate and/or obviate the afore-described disadvantages of the conventional electron microscopes.

### SUMMARY OF THE INVENTION

The primary objective of the present invention is to provide a remote control electron microscope including an image taking device for taking the images and for sending the image signals to an imaging treating device without any coupling cables or the like such that the image taking device may be freely moved to any place or position for appropriately take the required images and for taking the images from the best angles.

In accordance with one aspect of the invention, there is provided a remote control electron microscope comprising an image taking device including an image taking member for taking an image signal, and including means for converting the image signal to a radio frequency signal, an image treating device including a receiver device for receiving the radio frequency signal from the image taking device, and including means for demodulating the radio frequency signal to a demodulated image signal, and means for displaying the demodulated image signal. The image signals taken by the image taking device may be converted into the radio frequency signal and may be transmitted or emitted to the image treating device, such that the image taking device may be freely moved to any place or position for appropriately take the required images and for taking the images from the best angles.

The converting means includes an oscillator coupled to the image taking member for receiving and converting the image signal to the radio frequency signal.

A low pass filter is further provided and coupled to the oscillator for filtering unwanted signals and for preventing the unwanted signals from being transmitted to the oscillator.

A frequency control device is further provided and coupled to the low pass filter for controlling the low pass filter and for adjusting the ranges of the frequencies that may be filtered or passed by the low pass filter.

The image taking device includes an antenna, and includes a buffer device, a driving device and a power amplifier coupled between the antenna and the oscillator for treating and sending the radio frequency signal to the antenna.

An amplifier and a mixer and an oscillator are further provided and coupled to the receiver device for treating the radio frequency signal and for further amplifying and/or mixing and/or oscillating or treating the signals.

A frequency adjusting device is further provided and coupled to the oscillator for adjusting the radio frequency signal and for modifying the radio frequency signals and for maintaining the quality of the radio frequency signals.

The demodulating means includes a frequency demodulation circuit for demodulating the radio frequency signal to a demodulated image signal.

A medium frequency treating device is further provided and coupled to the frequency demodulation circuit for frequency compensating purposes.

The image treating device includes an image treating member coupled to the frequency demodulation circuit for treating and maintaining the demodulated image signal.

The image treating member includes at least one amplifier coupled to the frequency demodulation circuit for amplifying the demodulated image signal.

A limiter device may further be provided and coupled to the amplifier for modifying the demodulated image signal.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a remote control electron microscope in accordance with the present invention;

FIG. 2 is an exploded view of an image taking device;

FIG. 3 is a perspective view illustrating the other embodiment of the image taking device;

FIG. 4 is a block diagram illustrating the elements for the image taking device;

FIG. 5 is an electric circuit illustrating the elements for an image treating device; and

FIG. 6 is a perspective view illustrating the operation of the remote control electron microscope.

### DETAILED DESCRIPTION OF THE PREFERRED EMBODIMENT

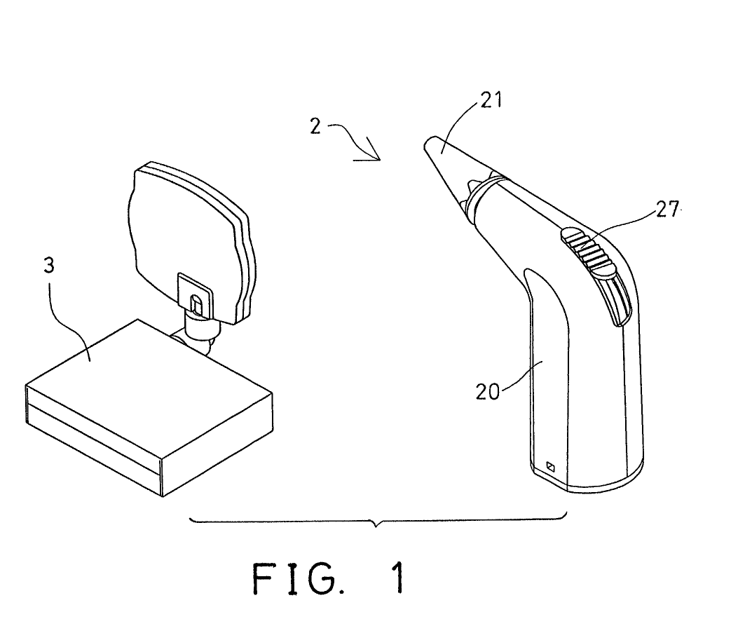

Referring to the drawings, and initially to FIG. 1, a remote control electron microscope in accordance with the present invention comprises an image taking device 2 for taking the images and for sending the image signals to an imaging treating device 3 without any coupling cables or the like such that the image taking device 2 may be freely moved to any place or position for appropriately take the required images and for taking the images from the best angles.

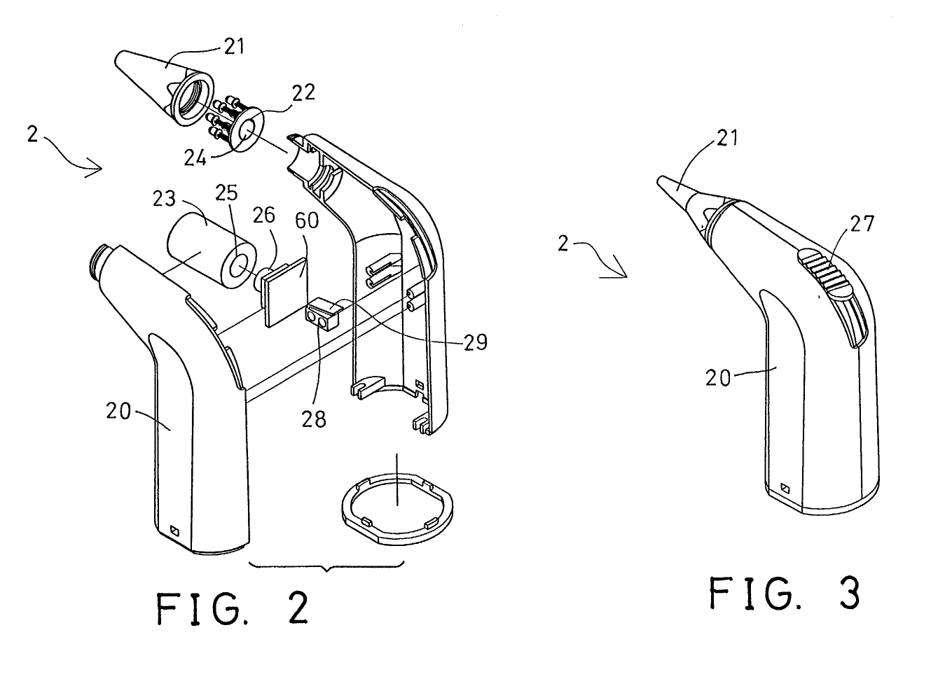

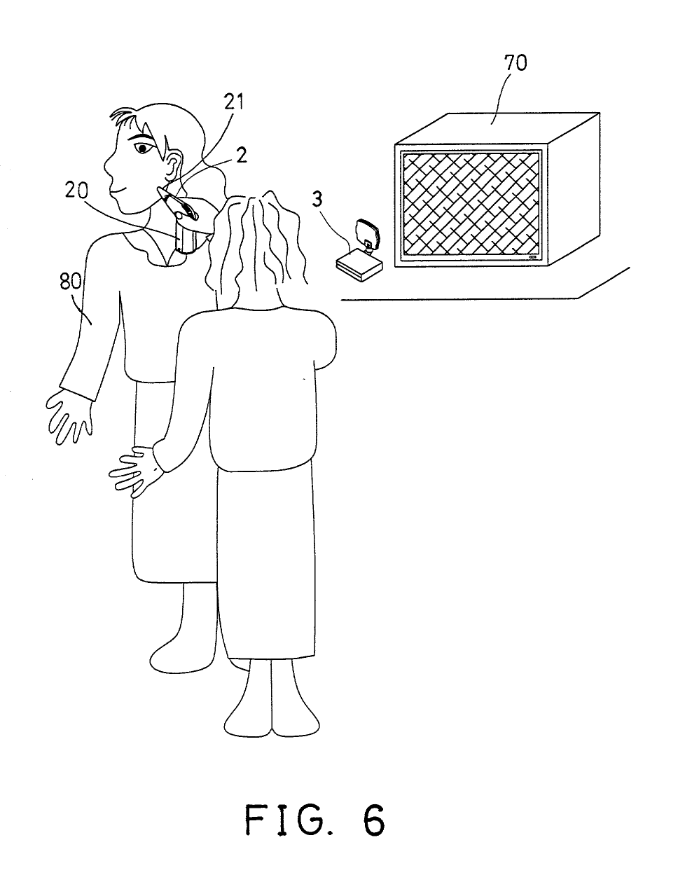

Referring next to FIG. 2, the image taking device 2 includes a handle or a housing 20 having such as two half members secured together with fasteners, adhesive materials, or by welding processes, or the like. A hood 21 is secured to the front end of the housing 20, for directing toward the places or the positions required to be taken with the images. For example, as shown in FIG. 6, the hood 21 may be directed toward the face of a patient 80 or the like for taking the images of the skin tissues of the patient 80 or the like. The hood 21 may include different shapes, as shown in FIGS. 1-3, for providing different usages, for example.

As also shown in FIG. 2, a light device 22 is engaged in the housing 20 and preferably engaged in or arranged behind the hood 21 for providing or shining a light against the places or the positions required to be taken with the images. The light device 22 includes a bore 24 formed therein. A barrel 23 is engaged in the front portion of the housing 20 and disposed behind the light device 22, and includes an orifice 25 formed therein and aligned with the bore 24 of the light device 22. An image taking member 26, such as a video camera, a charge coupled device, or the like, is engaged in or aligned with the orifice 25 of the barrel 23 for directing toward the places or the positions required to be taken with the images.

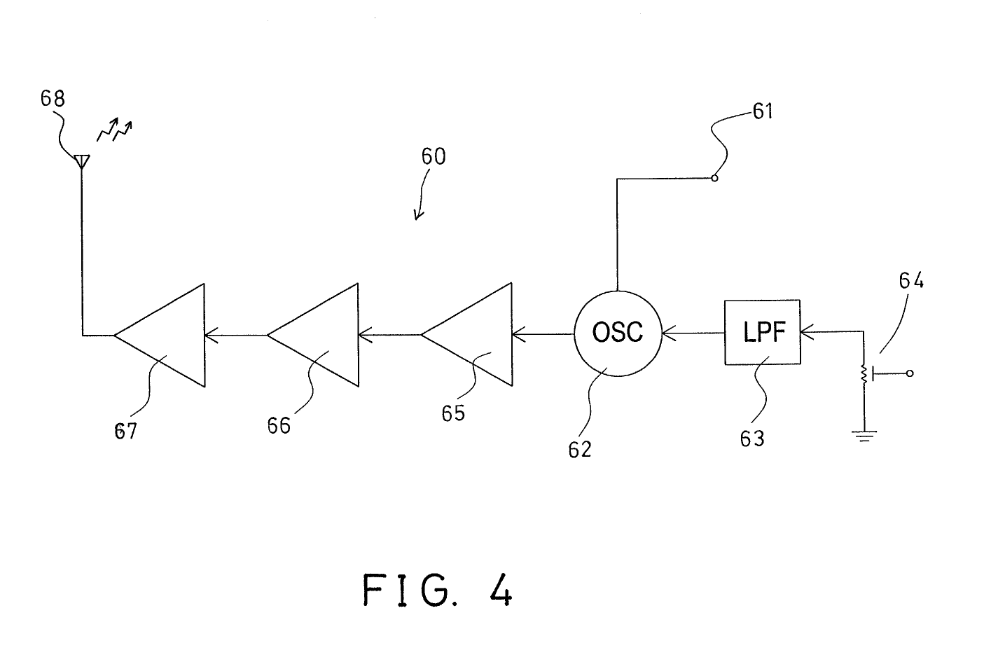

A control circuit 60 or the like is also disposed in the housing 20 and coupled to the image taking member 26 for treating the images or signals taken by the image taking member 26 and for sending the image signals out toward an image treating device 3 (FIGS. 1, 5, 6) or the like. As shown in FIG. 4, the control circuit 60 includes one end or a terminal 61 coupled to the image taking member 26 for receiving the images or the image signals from the image taking member 26, and includes an oscillator (OSC) 62 coupled to the terminal 61 for treating or converting the image signals to such as a radio frequency signal or the like. A low pass filter (LPF) 63 is coupled to the oscillator 62 for filtering the high frequency signals or the other unwanted signals or the like, and for allowing only the required signals to be transferred to or through the oscillator 62. A frequency control device 64 may further be provided and coupled to the low pass filter 63 for controlling or adjusting the frequencies or the signals to be filtered by the low pass filter 63.

A buffer circuit or a buffer device 65 or the like is provided and coupled to the oscillator 62 for modifying the signals from the oscillator 62. A driving device 66 and a power amplifier 67 are coupled to the buffer device 65 for further treating the radio frequency signal and for sending the radio frequency signal to an antenna 68 or the like for sending or emitting the radio frequency signal out of the control circuit 60 and the housing 20 of the image taking device 2, and for emitting or transmitting the radio frequency signal toward the image treating device 3 (FIGS. 1, 5, 6) or the like.

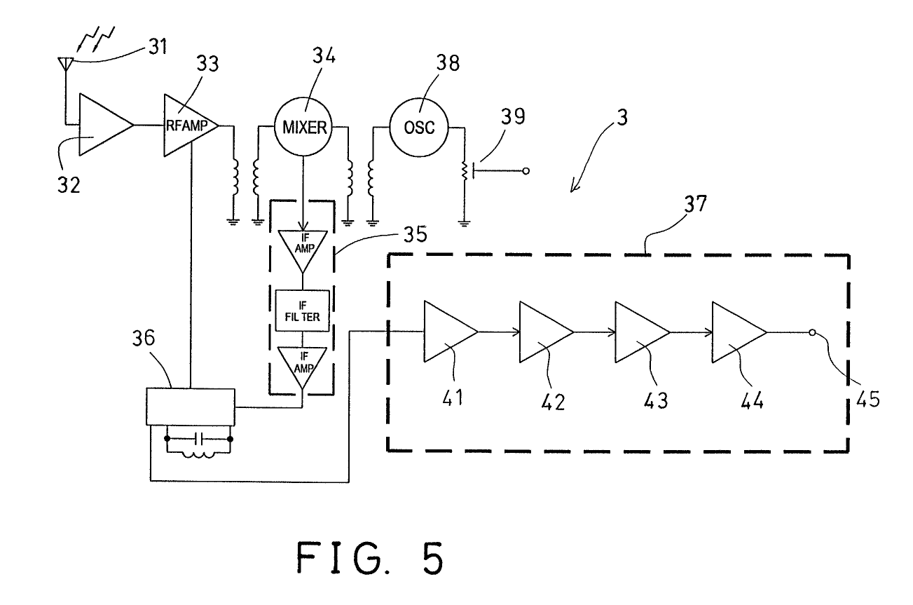

Referring next to FIG. 5, the image treating device 3 includes an antenna 31 for receiving the signals from the antenna 68 of the control circuit 60 of the image taking device 2. A receiver device 32 is coupled to the antenna 31 for receiving the signals from the antenna 31. An amplifier, such as a radio frequency amplifier 33 is coupled to the receiver device 32 for amplifying the signals of the receiver device 32, and a mixer 34 and an oscillator 38 are further provided and coupled to the amplifier 33 for further mixing or oscillating or treating the signals. A frequency adjusting device 39 may further be provided and coupled to the oscillator 38 for adjusting or modifying the radio frequency signals and for maintaining the quality of the radio frequency signals. A medium frequency treating device 35 is coupled to the mixer 34 for compensating the ranges or the frequencies or the like, and a frequency demodulation circuit 36 or the like is coupled to the medium frequency treating device 35 for feedback or modifying or demodulating the radio frequency signals back to the image signals.

An image treating circuit or member 37 is further provided and coupled to the frequency demodulation circuit 36 for further treating the image signals and for sending the image signals to and to be shown in a monitor or a displayer 70 (FIG. 6) or the like. The image treating member 37 includes a first and a second image signal amplifiers 41, 42 coupled to the frequency demodulation circuit 36, for amplifying the image signals from the frequency demodulation circuit 36. A limiter device 43 or the like and a third image signal amplifier 44 are further provided and coupled to the second image signal amplifier 42 for further modifying the waves or the wave shapes of the image signals, and for sending the modified image signals to a terminal 45 which may be coupled to the monitor or the displayer 70 (FIG. 6) or the like, for allowing the image signals to be shown in the displayer 70 or the like.

In operation, as shown in FIG. 6, the housing 20 of the image taking device 2 may be freely moved to any place or position, such as directed toward the face of the patient 80 or the like, for appropriately take the required images and for taking the images from the best angles. The image signals taken by the image taking member 26 (FIG. 2) may then be treated or converted into a radio frequency signal by such as the oscillator 62 (FIG. 4) of the control circuit 60 of the image taking device 2. The radio frequency signal may then be transmitted to the image treating device 3 which includes the frequency demodulation circuit 36 for modifying or demodulating the radio frequency signals back to the image signals and for allowing the image signals to be shown in the displayer 70.

Referring again to FIG. 2, a driving or moving device 28, such as a motor driven device or the like, is further provided and coupled to the control circuit 60 for moving or adjusting the control circuit 60 and/or the image taking member 26 toward or away from the hood 21 and for allowing the image taking member 26 to take the best or the most clear images. The moving device 28 includes a microswitch 29, for example, disposed thereon. A knob 29 is slidably engaged on the housing 20 for actuating the microswitch 29 to operate or the control the moving device 28.

Accordingly, the remote control electron microscope in accordance with the present invention includes an image taking device for taking the images and for sending the image signals to an imaging treating device without any coupling cables or the like such that the image taking device may be freely moved to any place or position for appropriately take the required images and for taking the images from the best angles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A remote control electron microscope comprising:
an image taking device including an image taking member for taking an image signal, and including means for converting the image signal to a radio frequency signal,
an image treating device including a receiver device for receiving the radio frequency signal from said image taking device, and including means for demodulating the radio frequency signal to a demodulated image signal, and
means for displaying the demodulated image signal.

2. The remote control electron microscope according to claim 1, wherein said converting means includes an oscillator coupled to said image taking member for receiving and converting the image signal to the radio frequency signal.

3. The remote control electron microscope according to claim 2 further comprising a low pass filter coupled to said oscillator for filtering unwanted signals and for preventing the unwanted signals from being transmitted to said oscillator.

4. The remote control electron microscope according to claim 3 further comprising a frequency control device coupled to said low pass filter for controlling said low pass filter.

5. The remote control electron microscope according to claim 2, wherein said image taking device includes an antenna, and includes a buffer device, a driving device and a power amplifier coupled between said antenna and said oscillator for treating and sending the radio frequency signal to said antenna.

6. The remote control electron microscope according to claim 1 further comprising an amplifier and a mixer and an oscillator coupled to said receiver device for treating the radio frequency signal.

7. The remote control electron microscope according to claim 6 further comprising a frequency adjusting device coupled to said oscillator for adjusting the radio frequency signal.

8. The remote control electron microscope according to claim 6, wherein said demodulating means includes a frequency demodulation circuit for demodulating the radio frequency signal to a demodulated image signal.

9. The remote control electron microscope according to claim 8 further comprising a medium frequency treating device coupled to said frequency demodulation circuit for frequency compensating purposes.

10. The remote control electron microscope according to claim 8, wherein said image treating device includes an image treating member coupled to said frequency demodulation circuit for treating and maintaining the demodulated image signal.

11 The remote control electron microscope according to claim 10, wherein said image treating member includes at least one amplifier coupled to said frequency demodulation circuit for amplifying the demodulated image signal.

12. The remote control electron microscope according to claim 11 further comprising a limiter device coupled to said at least one amplifier for modifying the demodulated image signal.
